(19) United States
(12) Patent Application Publication
(10) Pub. No.: US 2026/0332440 A1
(43) Pub. Date: Oct. 22, 2026

(54) TRACKING VOTES BY DISTRIBUTED LEDGER NODES ON VALIDITY OF TRANSACTION CONTENTS

(71) Applicant: Dell Products L.P., Round Rock, TX (US)

(72) Inventors: Ahmed Khalid, Cork (IE); Alan Barnett, Co. Cork (IE); Judith A. Furlong, Natick, MA (US)

(21) Appl. No.: 19/184,553

(22) Filed: Apr. 21, 2025

(51) Int. Cl. H04L 9/00; G06F 9/54; H04L 67/104

(52) U.S. Cl. CPC H04L 9/50; G06F 9/54; H04L 67/104

(57) ABSTRACT

Securing network nodes of a distributed ledger by detecting undesirable content is disclosed. When a transaction is received from a client, content of the transaction is analyzed for undesirable content by each of the nodes. The nodes may perform customized content analysis that differs from node to node. The nodes, after performing the content analysis, vote on whether to accept the transaction. When consensus is achieved among the nodes, the transaction is committed to the distributed ledger. When committing the transaction, a header containing a voting history of each of the nodes is added to the transaction. Nodes that voted to reject the transaction store a hash of the transaction rather than the transaction itself.

### TECHNOLOGICAL FIELD OF THE DISCLOSURE

Embodiments disclosed herein generally relate to distributed ledger technologies. More particularly, at least some embodiments relate to systems, hardware, software, computer-readable media, and methods for committing transactions to distributed ledger nodes and more particularly to detecting undesirable content in transactions and to tracking votes by the distributed ledger nodes.

### BACKGROUND

Distributed ledger technologies (DLTs) (e.g., blockchains) are decentralized systems that enable transactions to be recorded across multiple nodes within a distributed ledger network. The ability to immutably store transactions is a significant benefit of DLTs. When committing a transaction to a distributed ledger network, cryptographic techniques are used to create an immutable and chronological chain of transactions (e.g., blocks or graphs). The chain of transactions, and the content within the transactions, is stored on all the nodes in the DLT network. This configuration ensures that no single entity has complete control of the transactions or has the ability to tamper with the content. The distributed and tamper-resistant nature of DLTs enhances transparency, reduces the risk of fraud, and facilitates trust among participants in the distributed ledger network. These characteristics make DLTs suitable for applications such as cryptocurrencies, smart contracts, and supply chain management.

These characteristics can also complicate the ability to resolve security and compliance concerns. For example, much effort has been given to identify security and compliance concerns related to hosting public immutable data in an organization’s network and to devise solutions that can mitigate threats and non-compliance.

For example, security/compliance issues facing organizations that host public immutable data include issues related to undesirable content, such as illegal content. Freely editable fields, for example, are exploited to place illegal content in a DLT. The illegal content often includes the kind of imagery that is illegal in virtually every country but could also include content such as leaked personal identifying information.

Storing or distributing illegal content is a significant problem for DLT services and DLT participants. Nonetheless, prominent DLTs presently have instances of such imagery or other illegal content. There is low impetus for removing illegal content even amongst platforms where removal is relatively trivial, such as in social media. Removing illegal content from a DLT typically requires enormous effort due to the immutable nature of the DLT. For example, carrying out a hard fork may resolve the issue, but involves substantial effort.

Other than the effort of removal, the presence of illegal content on a DLT does not functionally impact the day-to-day running of the DLT and until recently, there has not been significant pressure or consequences imposed by authorities to motivate these platforms to combat the issue.

The implications of illegal content do not stop at the platform or service provider level. When illegal content is placed on a node of a DLT, the illegal content will propagate to other nodes in the DLT, which are under an obligation to run in compliance with the up-to-date network version. The person or entity running the DLT node, as a consequence, may be technically in possession of illegal content.

Undesirable content may also pose a potential security vulnerability. For instance, injecting content into the DLT could be used for backdoor patching viruses already deployed or may be leveraged as part of an injection attacked.

Recently, various jurisdictions and collectives are placing increased responsibility on DLT platforms and services to combat illegal content on their systems. Examples include the European Union’s Digital Services Act and the United Kingdom’s Online Safety Bill. While social media and file shares are a primary focus of this legislation, DLTs are in an untenable position and need to address these concerns to preserve functionality and maintain compliance.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of a distributed ledger;

FIG. 2 discloses aspects of committing a transaction to a distributed ledger;

FIG. 3 discloses aspects of detecting undesirable content and preventing undesirable content from being stored in a distributed ledger;

FIG. 4 discloses additional aspects of committing a transaction by nodes that rejected the transaction during execution of a consensus mechanism; and

FIG. 5 discloses aspects of a computing device, system, or entity.

### DETAILED DESCRIPTION OF SOME EXAMPLE EMBODIMENTS

Embodiments disclosed herein generally relate to distributed ledger technologies (DLTs). More particularly, at least some embodiments relate to systems, hardware, software, computer-readable media, and methods for preventing undesirable content from being committed to distributed ledgers. Embodiments of the invention further relate to tracking votes related to a consensus mechanism and allowing distributed ledger nodes that reject a transaction to store only a representation thereof.

Embodiments of the invention relate to DLTs, such as blockchains, where autonomous decentralized nodes work together to create replicas of an immutable ledger. Embodiments of the invention may be implemented in various DLT platforms or services and can be adapted to the details (e.g., protocols, architectures) of specific DLTs. Hedera, Bitcoin, Ethereum, and Hyperledger are examples of DLTs in which embodiments of the invention may be implemented. DLTs and the like are referred to herein as distributed ledgers by way of example. In one example, each node participating in a distributed ledger maintains a copy of the distributed ledger.

Embodiments of the invention are discussed in the context of a distributed ledger and transactions that are stored or committed to the distributed ledger. Distributed ledgers may be public, private, permissioned, permissionless, or the like. A distributed ledger may include nodes (e.g., servers, clusters with processors and memory) and the nodes may be implemented in the cloud, at the edge, on-premise, or the like or combinations thereof.

By way of example and not limitation, a distributed ledger may be associated with transactions and messages. A transaction may relate to changes in the ledger. Example transactions may relate to digital assets, digital currency, asset transfer, recording data, smart contracts, or the like or combinations thereof. Generally, valid transactions are committed to the distributed ledger. Messages, in contrast, may be used to convey information and messages may or may not be committed to the distributed ledger. For example, messages may be used for status updates, commands, voting, protocols, node communications, or the like or combinations thereof. Embodiments of the invention focus on transactions that result in changes to the distributed ledger and are immutably stored therein. More generally, embodiments of the invention relate to data that is committed to a distributed ledger and may be applied to various DLTs, which may use different protocols and communication methods.

In some examples, each node of a distributed ledger may be configured to conduct a content analysis operation to identify undesirable content. However, different nodes may have different perceptions of what qualifies as undesirable content. Designating content as undesirable content may be influenced by location, local regulations, and the like. Thus, content that is acceptable from the perspective of one node may be undesirable from the perspective of another node. Embodiments of the invention provides nodes with flexibility to make their own determinations based on their specific circumstances and requirements and provide various methods for committing a transaction deemed acceptable by the nodes of the distributed ledger.

Embodiments of the invention may provide or include application programming interfaces (APIs) that can be used by the nodes when making a decision as to whether or not to accept a transaction or to identify undesirable content in a transaction. Content of a transaction (or the transaction itself) can be passed to analyzers (e.g., content analyzers, compliance analyzers) using these APIs.

Nodes of a distributed ledger are often required to commit approved transactions to their respective copies of the distributed ledger. Embodiments of the invention allow each node (or node operator) to run their own content (and/or compliance) analysis operations. As a result, a scenario may arise where nodes of the distributed network reach consensus to commit a particular transaction to the distributed ledger even though some nodes vote to reject the transaction. In these scenarios, the nodes that flag the transaction (e.g., because the content is deemed undesirable by the node) will be required to store the transaction in their copies of the distributed ledger in order to maintain compliance with the consensus protocol and the distributed ledger network.

Problems associated with storing undesirable content are addressed, in one example, by adding a header (e.g., a header field, metadata) to the transaction or block (i.e., the immutable unit in the distributed ledger) to track the votes of the nodes in the distributed ledger. Conventionally, the voting process and results are not tracked by consensus mechanisms. The focus is on achieving consensus on the transactions with proofs. Adding a header for storing aspects and/or results of the consensus mechanism (e.g., the voting process) ensures that results of the vote are stored directly in the copies of the distributed ledger and can help organizations (node operators) in fulfilling any future compliance assessments or audits mandated by regulatory authorities. Furthermore, tracking the votes enables nodes that object to the transaction to generate and write hashes (or other representations) of the transaction to their copies of the distributed ledger, while maintaining pointers to nodes that persisted the transaction to their copies of the distributed ledger. Embodiments of the invention may be implemented with various voting operations performed by a consensus mechanism such as, but not limited to, Delegated Proof of Stake, Byzantine Fault Tolerance (BFT) algorithms, Hashgraph.

Embodiments of the invention allow nodes to detect, report, reject, or save transactions from clients to their respective copies of the distributed ledger, irrespective of the decisions made by other nodes in the distributed ledger.

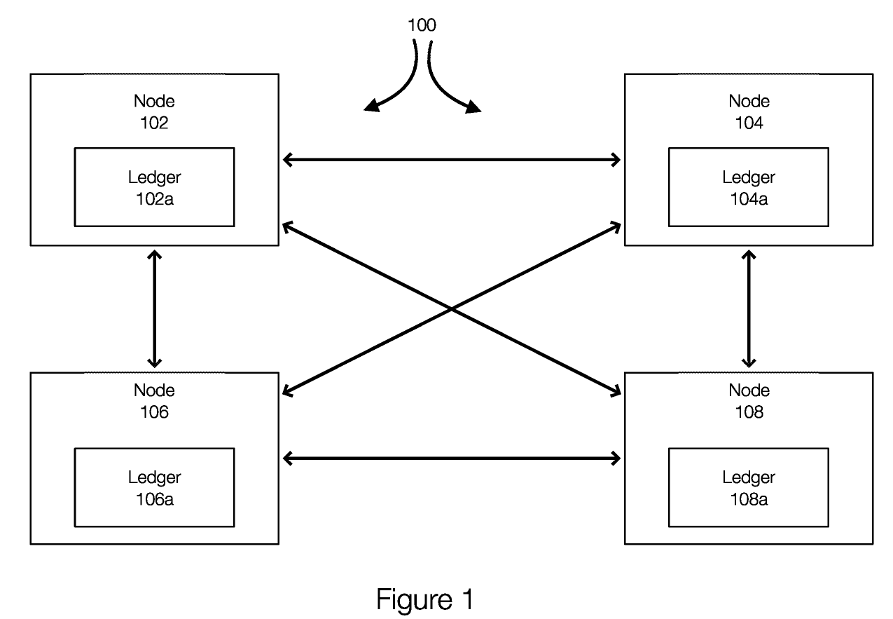

FIG. 1 discloses aspects of an example distributed ledger. A distributed ledger 100 includes nodes, represented as nodes 102, 104, 106, and 108. The nodes 102, 104, 106, and 108 may be associated with different operators, in different geographical locations, connected to different networks, and the like. The distributed ledger 100 is implemented by creating a replica or copy of the ledger at each of the nodes. Thus, the distributed ledger 100 is represented by copies of the ledger stored at or accessible by the nodes 102, 104, 106, and 108. The nodes 102, 104, 106, and 108 are able to communicate with one another.

In this example of the distributed ledger 100, the node 102 stores and runs a copy or replica of the ledger, illustrated as the ledger 102a. The copies or replicas of the distributed ledger stored and run by the nodes 104, 106, and 108 are represented as, respectively, ledgers 104a, 106a, and 108a. The ledgers 102a, 104a, 106a, and 108a may be implemented in non-transitory memory or storage devices.

In this example of the distributed ledger 100, the network nodes 102, 104, 106, and 108 store the transactions that are received by the distributed ledger 100 to their respective internal storage – the ledgers 102a, 104a, 106a, and 108a. This may lead to potential legal or technical challenges if content in the transactions is or includes undesirable content (e.g., malicious content, illegal content, non-compliant content). In some examples, the manner in which a transaction is committed to the distributed ledger may depend on whether the content of the transaction is viewed as undesirable.

In one example, network nodes 102, 104, 106, and 108 receive transactions from clients. For example, the distributed network 100 may be used to store digital wallets, each associated with a different client. A client may desire to transfer an asset to another client or elsewhere and this is achieved by sending a transaction to or initiating a transaction in the distributed ledger 100.

The nodes 102, 104, 106, and 108 validate transactions and execute a consensus mechanism for each of the transactions. Once consensus is reached among the nodes 102, 104, 106, and 108 with respect to a particular transaction, each node adds that particular transaction and the associated content to its corresponding replica or copy of the distributed ledger. In some examples, cryptographic techniques are used. Thus, the node 102 adds the validated transaction to the ledger 102a, the node 104 adds the validated transaction to the ledger 104a, the node 106 adds the validated transaction to the ledger 106a, and the node 108 adds the validated transaction to the node 108a. This creates replicas of an immutable transaction log across all the network nodes 102, 104, 106, and 108.

In this example, transactions, but not messages, are committed to the distributed ledger. In other examples, transactions and messages are committed to the distributed ledger. More generally, different DLTs may have different protocols and terminology. This example assumes that at least transactions are committed to the distributed ledger 100.

Further, a transaction may be received at one node (e.g., the node 102) or at multiple nodes (e.g., at the nodes 102 and 104). The distributed ledger 100 may have a mechanism or protocol to forward or share the transaction with the other nodes in the distributed ledger 100. This ensures that the ledgers 102a, 104a, 106a, and 108a are kept up to date and consistent over time as transactions are validated and reviewed for undesirable content.

In one example, during the consensus mechanism, the node 102 may vote to reject the transaction while the other nodes 104, 106, and 108 vote to accept the transaction. Although consensus is achieved (e.g., majority of nodes voted to accept the transaction), the manner in which the transaction is committed to the distributed ledger may vary at each node.

For example, the nodes 104, 106, and 108 may add a header to the transaction and commit both the header and the transaction to, respectively, the ledgers 104a, 106a, and 108a. The header may identify all nodes that voted to accept the transaction or identify all nodes and their vote.

The node 102 also generates the same header in one example. However, the node 102 may store a hash of the content (or of the transaction) in the ledger 102a. Proofs are also stored or available with regard to the hash. This allows the node 102 to store the transaction in the ledger 102a without actually storing the undesirable content. If the node 102 receives a request for this transaction, the request may be directed to other nodes, using the nodes that voted to accept the content in the header. In one example, the values placed in the headers can be verified, enforced, audited, secured, and the like such that the headers are legitimate representations of the nodes that voted and the content of their vote. The voting mechanism may provide the ability to legitimately add this type of header. The validity of the hash can be verified using the content stored on other nodes of the distributed ledger.

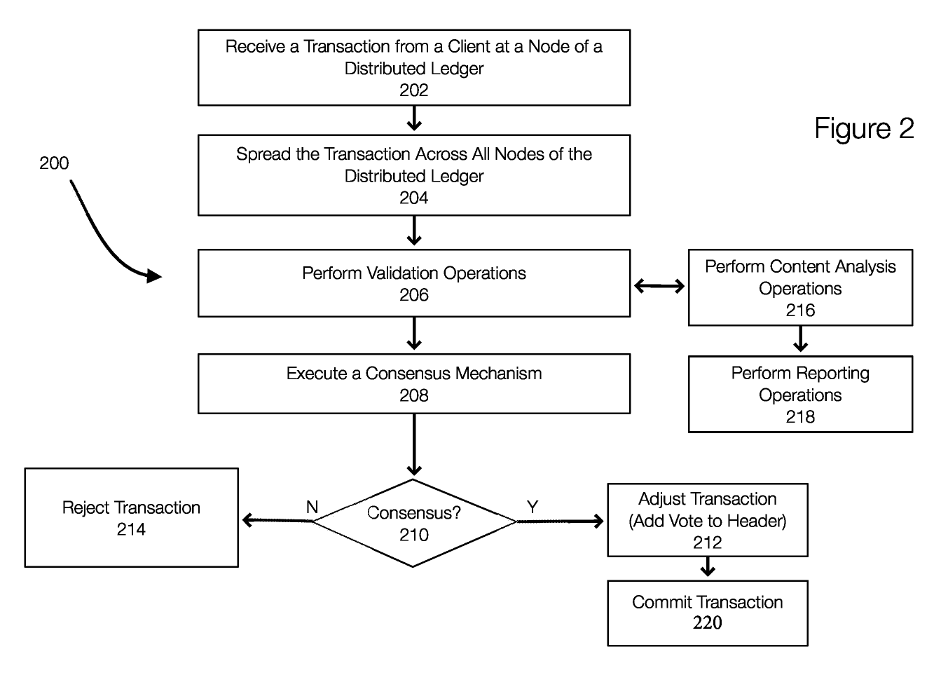

FIG. 2 discloses aspects of persisting a transaction to a distributed ledger. The method 200 may include receiving 202 a transaction from a client (e.g., a sender) at a node (or multiple nodes) of a distributed ledger. The node or nodes receiving the transaction may perform a protocol (e.g., a broadcast or gossip protocol) to spread 204 the transaction across all nodes of the distributed ledger.

In one example, each of the nodes may perform 206 validation operations. In some examples, specific nodes may be identified as consensus nodes may be tasked with determining whether to accept or reject a transaction in the distributed ledger. In this example, validation operations are performed 206 by all nodes in the distributed ledger and all nodes are considered to be consensus nodes.

In one example, the validation operations may include verifying the digital signatures of the client (e.g., the sender), ensuring that the transaction follows an acceptable format, and confirming that the sender has sufficient funds.

Performing 206 the validation operations may also include performing 216 content analysis operations. In one example, the content analysis operations may be accessed using APIs. Using APIs allows each node to perform their own content analysis (each node may use a different API or provide different arguments to an API). In one example, the content analysis functions or operations accessed by a particular node is configured to identify undesirable content from that node’s perspective. Thus, the content analysis performed by one node may be different from the content analysis performed at other nodes. The content analysis operations performed by or for each node may include organization specific or node specific content analysis operations.

In one example, an organization may require transactions to include a certain value in a particular field, which may not be required by other organizations hosting a node of the distributed ledger. Thus, the content analysis operations performed by that node may include a check to determine whether that particular field contains a valid value or entry. This may result in a situation where one node votes against the transaction (reject) due to a node-specific compliance requirement while another node may vote to accept the transaction.

After the transaction is validated (or not validated) by the nodes (or the consensus nodes or sufficient portion thereof) and the content analysis determines that the transaction or its content is acceptable (or not acceptable), a consensus mechanism may be executed 208. Each node may vote according to the result of their validation and/or content analysis operations. Each of the nodes may perform 218 reporting operations. For example, nodes that identify undesirable content may report the content or the transaction to an auditor, a relevant authority, or the like.

The consensus mechanism may take a variety of forms. In one example, each node casts a virtual vote on whether the transaction (or content) is acceptable or whether the transaction (or content) should be rejected. Thus, a node may vote accept or reject (e.g., via a Boolean response) in one example. The votes may be counted and where a sufficient number of accept votes are cast, consensus (Y at 210) is achieved.

In this example when consensus is achieved, each node may adjust 212 the transaction. More specifically, nodes that voted to accept the transaction may add a header to the transaction that includes the nodes that voted and their vote (e.g., accept or reject). Other information may be included (e.g., reasons of the nodes that rejected the transaction). Once the header is finalized, the transaction, with its header, is committed 220 to the distributed ledger by the nodes that voted to accept the transaction.

Nodes that voted to reject the transaction also adjust 212 their copy of the transaction by creating a header reflecting the votes as previously described. In addition, in one example, the transaction (or content or portion of the content) is hashed. Thus, the nodes that voted to reject the transaction store the header and a hash of the transaction (or portion thereof) when committing 220 the transaction to their copy of the distributed ledger. The header may also be hashed in one example.

If the transaction does not received enough accept votes, the voting does not reach the required threshold (N at 210). Because consensus is not achieved by the consensus mechanism, the transaction is rejected 214 and not stored in the distributed ledger by any of the nodes.

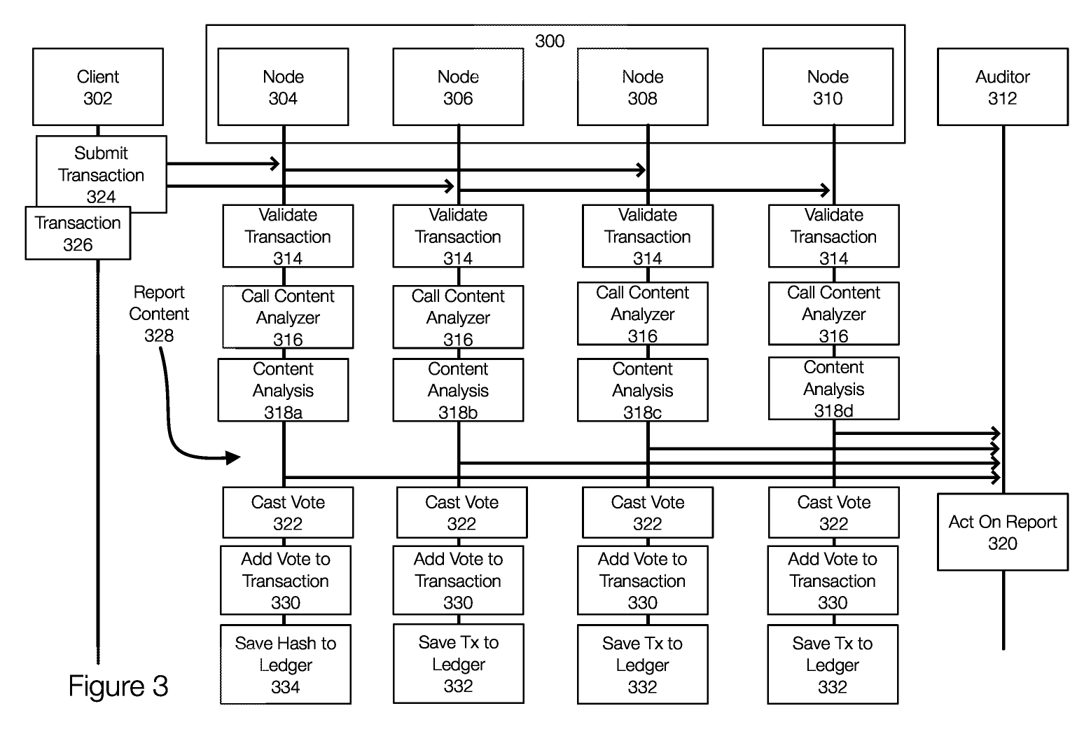

FIG. 3 discloses additional aspects of detecting undesirable content and preventing undesirable content from being stored at the replica ledgers maintained by nodes participating in a distributed ledger. FIG. 3 further discloses aspects of storing transactions by nodes that voted to reject a transaction that has achieved consensus in the distributed ledger.

FIG. 3 illustrates a distributed ledger 300 that includes nodes 304, 306, 308, and 310. In this example, a client 302 submits 324 a transaction 326 to nodes 304 and 306. Thus, the transaction 326 is received at nodes 304 and 306 of the distributed ledger 300. The transaction is then spread by the receiving nodes to the other nodes in the distributed ledger 300. In this example, the node 304 spreads the transaction 326 to the node 308 and the node 306 spreads the transaction 326 to the node 310.

Next, the nodes 304, 306, 308, and 310 validate 314 the transaction. In one example, the validation 314 is substantially the same at each of the nodes 304, 306, 308, and 310. These validation operations may include verifying signatures, verifying a format of the transaction (or message), ensuring that the client 302 has a sufficient balance, or the like.

Next, the nodes 304, 306, 308, and 310 call 316 their respective content analysis functions (e.g., 318a-d) using respective APIs. More specifically, in this example, the node 304 is associated with a content analysis 318a, the node 306 is associated with a content analysis 318b, the node 308 is associated with a content analysis 318c, and the node 310 is associated with a content analysis 318d. The content analysis 318a is specific to the requirements of the node 304. Similarly the content analysis 318b, 318c, and 318d are specific to the requirements of, respectively, the nodes 306, 308, and 310.

The content of the transaction 326 is analyzed by each of the nodes 304, 306, 308, and 310 using, respectively, the content analysis 318a, 318b, 318c, and 318d. The content analysis performed by the content analysis 318a-318d may be performed independently and separately. Further the content analysis 318a may differ from the other content analysis 318b-318d.

Content analysis operations may include, but are not limited to, detecting malicious elements (e.g., malware), content anomalies, fraudulent behavior, keywords as defined by a provider of the distributed ledger, illegal images, or the like or combinations thereof. The content of the transaction 326 can be analyzed using various rules, machine learning (e.g., a model trained on valid and/or undesirable content), or the like.

The ability of the node 304 to call 316 a content analyzer 318a and submit the transaction 326 for content analysis adds a dynamic aspect to the content analysis and allows each node to perform its own content analysis independently of the other nodes in the distributed ledger. In addition, the consensus mechanism protocol is unaffected and can be deployed or upgraded on new or existing nodes of the distributed ledger 300, while providing organizations (or node operators) with the flexibility of applying their own specific content analysis. Each operator can generate their own content analysis functions and make them accessible via an API or in another manner.

The transaction 326 may include, by way of example only, free-form text fields that could be exploited to insert undesirable content. Thus, the content analysis 318a can evaluate or analyze the content in accordance with requirements of the node 304. Conventional fields may also be evaluated.

The nodes 304, 306, 308, and 310 may or may not report 328 to an auditor 312. For example, the transaction 326 may be reported only when undesirable content is detected. The auditor 312 may be an external auditor, a regulatory body, a compliance team, and/or the like. The report may include an identity of the client 302, a reason for submitting the report or flagging the transaction 326, the undesirable content, or the like or combinations thereof.

Because the content analysis 318a, 318b, 318c, and 318d are different in some examples, undesirable content may be reported by only some of the nodes. Further, a response of the content analysis 318a-318d, via the API, may be a Boolean value indicating whether the transaction should be accepted or rejected.

The auditor 312 may act 320 on the report. If the auditor 312 is sufficiently associated with the distributed ledger 300, the auditor 312 may, of its own accord, reject the transaction. Alternatively, the auditor 312 may notify a relevant authority. This may be performed automatically. For example, if the node 304 issues a report that the transaction 326 includes illegal content, the auditor 312 may act 320 only with respect to the jurisdiction or regulatory authority associated with the node 304 at least because the content was not reported as illegal by the other nodes in this example.

In another example, after reporting 328 the content (or not reporting the content 328), the consensus mechanism is executed. In this example, the consensus mechanism for the nodes 304, 306, 308, and 310 includes casting votes 322 (e.g., virtual votes). Each node may vote to accept the transaction or reject the transaction. Casting votes 322 determines whether the transaction 326 is saved 332 to the ledger (e.g., the nodes commit the transaction 326 to their respective replicas or copies of the distributed ledger).

In one example, consensus is achieved when accept or yes votes achieve a required voting threshold level (e.g., above 50 %, above 66 %), which voting threshold level may be determined by the distributed ledger.

In one example, the nodes 306, 308, and 310 vote to accept the transaction 326 and the node 304 votes to reject the transaction 304. Consensus is achieved in this example. However, the transaction is committed to the respective ledgers differently. The nodes 306, 308, and 310 add 330 the votes of all nodes to the transaction (e.g., as a header or metadata). The header may identify each voting node and their vote. Once the header is added to the transaction, the nodes 306, 308, and 310 save 332 the transaction to the ledger. Requests for the transaction 326 by the nodes 306, 308, and 310 can be serviced by those nodes.

The node 304, which voted to reject the transaction, similarly adds 330 a header or metadata reflecting the votes of all of the nodes. However, the node 304 may generate a hash of the transaction (e.g., a hash of the transaction, of undesirable content of the transaction, of the header and the transaction). The node 304 then saves 334 the hash of the transaction to its copy of the distributed ledger. In one example, the node 304 saves the header and the hash.

Requests for the transaction 326 received by the node 304 can be redirected to one of the nodes 306, 308, and 310 using the header or metadata associated with the transaction. More specifically, the header identify which of the nodes actually store the content of the transaction based on their vote. The request will be directed to a node that stored the actual content or transaction. This may relieve the node 304 (or its operator) consequences related to storing, for example, illegal content.

Advantageously, embodiments of the invention ensure that each nodes stores either the content itself or a hash of the content along with pointers to the content. Clients can access the content and establish data integrity using any of the nodes. Embodiments of the invention allow nodes to reject content that do not comply with their regulations and policies while ensuring that the distributed ledger operates smoothly in situations where the node-specific content analysis operations result in conflicting decisions.

When adding 330 the vote to the transaction 326, the consensus mechanism may ensure that the header is immutable, verifiable, and correct. In one example, the content analysis 318a-d ensures that each of the nodes 304, 306, 308, and 310 are involved in the process of deciding whether to accept the transaction 326 based on their own considerations and requirements. More specifically, each of the nodes 304, 306, 308, and 310 can determine independently of the other nodes whether the transaction 326 includes undesirable content.

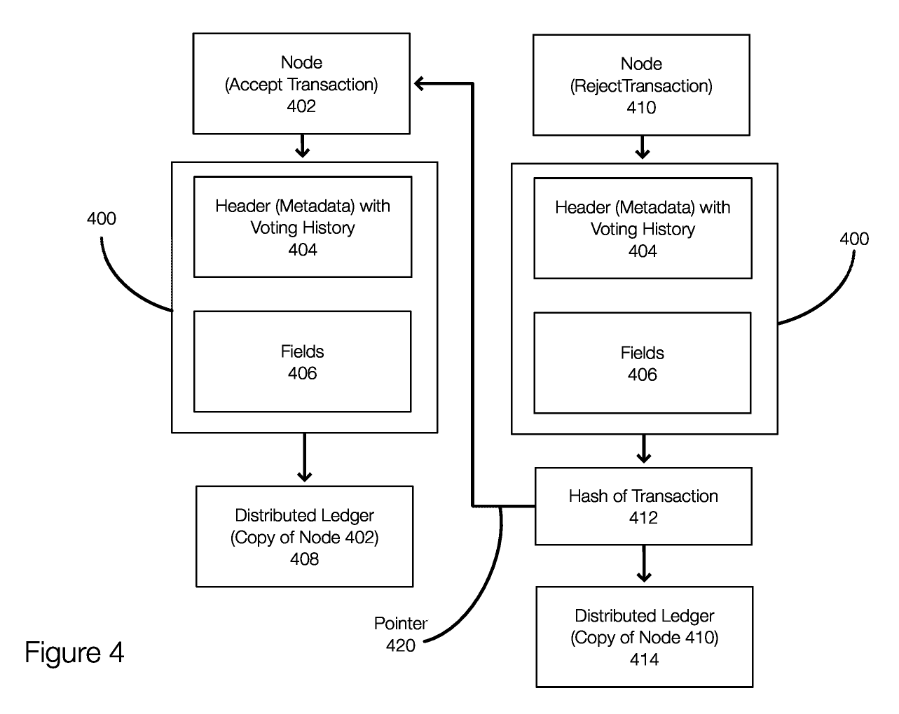

FIG. 4 discloses aspects of committing a transaction that is undesirable from the perspective of at least one node. FIG. 4 illustrates a transaction 400 for which consensus has been achieved. The node 402, which voted to accept the transaction, adds a header 404 to the transaction 400. The header 404, as previously described, may include tuples of (node, vote). This allows each node that voted to accept the transaction and the identity of the node to be discovered or determined. The fields 406, by way of example, may include data such as transaction identifier, account identifier, transaction fee, memo, signature, transaction body, or the like. Because consensus is achieved in this example, the node 402 commits the transaction 400 to the distributed ledger 408, which is the copy of the distributed ledger maintained by the node 402.

The node 410, which voted to reject the transaction, adds the same header 404 to the transaction 404. The node 410, however, generates a hash 412 of the transaction. The hash 412 may include or be associated with a pointer 420 to a node (e.g., the node 402) that stores the actual transaction. The pointer 420 may be included in the header 404 and/or may be derived from the identities of the nodes that voted to accept the transaction. In other words, a request to the node 410 for the transaction 404 may redirected to the node 402, which actually stored the transaction, using voting data stored in the header 404. Thus, the distributed ledger 414, which is a copy of the distributed ledger maintained by the node 410, stores the hash 412 rather than the content of the transaction 412.

In one example, the header 404 may or may not be included in the hash 412. Further, the node 410 may only generate a hash for the objectional content included in the transaction 400. In this case, the node 410 would store a hybrid (part transaction/part hash).

Advantageously, embodiments of the invention ensure that undesirable content is rejected even if one or more entry points (nodes that that received the transaction from the client) are compromised. Undesirable content is saved to the distributed ledger only if the required threshold of nodes are compromised. Advantageously, accurate content rejection and reporting is as reliable as the distributed ledger itself. Embodiments of the invention prevent undesirable content from being stored in the distributed ledger, which removes the complicated process of removing undesirable content from an immutable distributed ledger.

As a result, content that is marked or voted as accepted (e.g., both validation and content analysis pass) by the required threshold of votes is persisted in the distributed ledger while content that does not receive the required votes is discarded and not written to the distributed ledger. As previously stated, however, nodes that objected to the content in a case where consensus is still achieved may store a representation (e.g., a hash) of the transaction with proofs.

Embodiments of the invention validate transactions in a manner that includes customized content analysis from the node’s perspectives. Analyzing the content of a transaction allows undesirable content, such as malicious content, unethical content, non-compliant data, and the like, which may be stored in or included in the transaction (e.g., in free-form text fields) to be identified and rejected. Further, embodiments of the invention involve all (or a threshold number) of nodes in the content analysis to protect against compromised nodes. Embodiments of the invention further ensure that malicious clients (senders) and/or their content is detected and reported.

Content determined to be undesirable is not written to the distributed ledger. Embodiments of the invention proactively and advantageously prevent undesirable content from being written to the distributed ledger. This is an improved outcome compared to removing undesirable content that has already been committed to the distributed ledger. Removing existing undesirable content is substantially more difficult (may require a hard fork) due to the immutable nature of the distributed ledger.

In one example, application programming interfaces (APIs) are provided that allow a node to pass the content of a transaction to content analyzer functions. This allows a variety of different functions to be implemented, adjusted, added, revised, and the like in order to detect undesirable content in a dynamic and changeable manner. In one example, the ability to customize the content analysis may prevent consensus such that undesirable content is rejected.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, distributed ledger operations, validation operations, content analysis operations, auditing operations, reporting operations, hashing operations, content replacement operations for nodes that object to the content/transaction, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software.

Example embodiments are applicable to any system capable of storing and handling various types of objects or data, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: validating, by nodes of a distributed ledger, a transaction received into the distributed ledger, performing, by each of the nodes: calling an application programming interface to access content analysis functions, performing a content analysis on content included in the transaction on the transaction using the content analysis functions, determining whether the transaction includes undesirable content, and casting a vote based on a result of the content analysis to accept the transaction into the distributed ledger or a vote to reject the transaction from being stored in the distributed ledger, and committing the transaction to the distributed ledger, by the nodes, when votes from the nodes to accept the transaction exceed a threshold voting requirement, wherein nodes that voted to reject the transaction store a hash of the transaction in their copies of the distributed ledger and nodes that voted to accept the transaction store the transaction in their copies of the distributed ledger.

Embodiment 2. The method of embodiment 1, further comprising: receiving the transaction at one or more of the nodes in the distributed ledger, wherein the transaction is received from a client, and spreading the transaction to all of the nodes in the distributed ledger.

Embodiment 3. The method of embodiment 1 and/or 2, wherein the undesirable content includes malicious content, anomalous content, content related to or indicative of fraudulent behavior, keywords defined by a provider of the distributed ledger, malware, and/or illegal content including illegal images.

Embodiment 4. The method of embodiment 1, 2, and/or 3, wherein the content analysis performed by a particular node is based on content and/or compliance requirements of that particular node, further comprising reporting the transaction to an auditor by the nodes that determine that the transaction includes the undesirable content, wherein the auditor is an external auditor, a regulatory body, or a compliance entity and is configured to act with respect to the nodes that reported the transaction.

Embodiment 5. The method of embodiment 1, 2, 3, and/or 4, further comprising adding a header to the transaction by each of the nodes.

Embodiment 6. The method of embodiment 1, 2, 3, 4, and/or 5, wherein the nodes that voted to reject the transaction each generate their own hash of the transaction.

Embodiment 7. The method of embodiment 1, 2, 3, 4, 5, and/or 6, wherein the header includes a voting history of each of the nodes for the transaction, the voting history including identities of nodes in the distributed ledger and their votes.

Embodiment 8. The method of embodiment 1, 2, 3, 4, 5, 6, and/or 7, further comprising receiving a request for the transaction at one of the nodes that voted to reject the transaction and redirecting the request to a node that voted to accept the transaction using the voting history stored in the header.

Embodiment 9. The method of embodiment 1, 2, 3, 4, 5, 6, 7, and/or 8, wherein the header is associated with proofs such that the header and/or the hash is verifiable.

Embodiment 10. The method of embodiment 1, 2, 3, 4, 5, 6, 7, 8, and/or 9, wherein the hash is configured such that the nodes storing the hash in their respective ledgers comply with requirements of the distributed ledger.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments or edge environment where one or more of a client, server, or other machine may reside and operate in a cloud environment or edge environment.

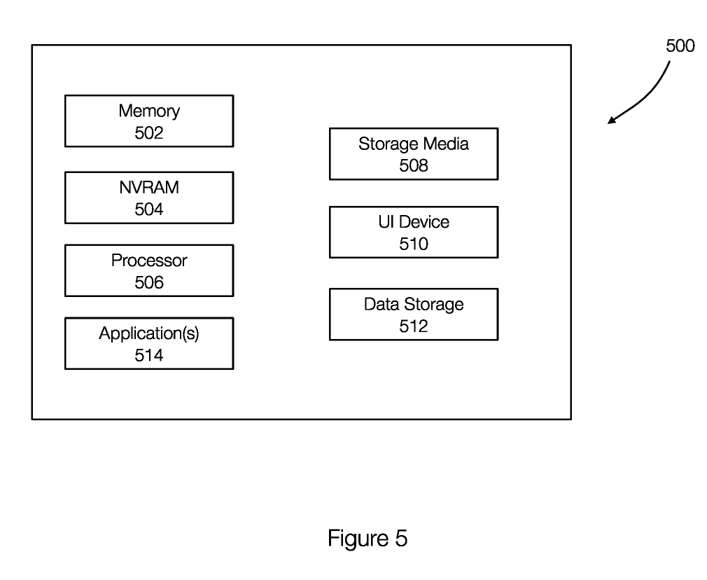

With reference briefly now to FIG. 5, any one or more of the entities disclosed, or implied, by Figures, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method comprising:
validating, by nodes of a distributed ledger, a transaction received into the distributed ledger;
performing, by each of the nodes:
calling an application programming interface to access content analysis functions;
performing a content analysis on content included in the transaction on the transaction using the content analysis functions;
determining whether the transaction includes undesirable content; and
casting a vote based on a result of the content analysis to accept the transaction into the distributed ledger or a vote to reject the transaction from being stored in the distributed ledger; and
committing the transaction to the distributed ledger, by the nodes, when votes from the nodes to accept the transaction exceed a threshold voting requirement,
wherein nodes that voted to reject the transaction store a hash of the transaction in their copies of the distributed ledger and nodes that voted to accept the transaction store the transaction in their copies of the distributed ledger.

2. The method of claim 1, further comprising:
receiving the transaction at one or more of the nodes in the distributed ledger, wherein the transaction is received from a client; and
spreading the transaction to all of the nodes in the distributed ledger.

3. The method of claim 1, wherein the undesirable content includes malicious content, anomalous content, content related to or indicative of fraudulent behavior, keywords defined by a provider of the distributed ledger, malware, and/or illegal content including illegal images.

4. The method of claim 3, wherein the content analysis performed by a particular node is based on content and/or compliance requirements of that particular node, further comprising reporting the transaction to an auditor by the nodes that determine that the transaction includes the undesirable content, wherein the auditor is an external auditor, a regulatory body, or a compliance entity and is configured to act with respect to the nodes that reported the transaction.

5. The method of claim 1, further comprising adding a header to the transaction by each of the nodes.

6. The method of claim 5, wherein the nodes that voted to reject the transaction each generate their own hash of the transaction.

7. The method of claim 5, wherein the header includes a voting history of each of the nodes for the transaction, the voting history including identities of nodes in the distributed ledger and their votes.

8. The method of claim 7, further comprising receiving a request for the transaction at one of the nodes that voted to reject the transaction and redirecting the request to a node that voted to accept the transaction using the voting history stored in the header.

9. The method of claim 7, wherein the header is associated with proofs such that the header and/or the hash is verifiable.

10. The method of claim 7, wherein the hash is configured such that the nodes storing the hash in their respective ledgers comply with requirements of the distributed ledger.

11. A non-transitory storage medium having stored therein instructions that are executable by one or more hardware processors to perform operations comprising:
validating, by nodes of a distributed ledger, a transaction received into the distributed ledger;
performing, by each of the nodes:
calling an application programming interface to access content analysis functions;
performing a content analysis on content included in the transaction on the transaction using the content analysis functions;
determining whether the transaction includes undesirable content; and
casting a vote based on a result of the content analysis to accept the transaction into the distributed ledger or a vote to reject the transaction from being stored in the distributed ledger; and
committing the transaction to the distributed ledger, by the nodes, when votes from the nodes to accept the transaction exceed a threshold voting requirement,
wherein nodes that voted to reject the transaction store a hash of the transaction in their copies of the distributed ledger and nodes that voted to accept the transaction store the transaction in their copies of the distributed ledger.

12. The non-transitory storage medium of claim 11, further comprising:
receiving the transaction at one or more of the nodes in the distributed ledger, wherein the transaction is received from a client; and
spreading the transaction to all of the nodes in the distributed ledger.

13. The non-transitory storage medium of claim 11, wherein the undesirable content includes malicious content, anomalous content, content related to or indicative of fraudulent behavior, keywords defined by a provider of the distributed ledger, malware, and/or illegal content including illegal images.

14. The non-transitory storage medium of claim 13, wherein the content analysis performed by a particular node is based on content and/or compliance requirements of that particular node, further comprising reporting the transaction to an auditor by the nodes that determine that the transaction includes the undesirable content, wherein the auditor is an external auditor, a regulatory body, or a compliance entity and is configured to act with respect to the nodes that reported the transaction.

15. The non-transitory storage medium of claim 11, further comprising adding a header to the transaction by each of the nodes.

16. The non-transitory storage medium of claim 15, wherein the nodes that voted to reject the transaction each generate their own hash of the transaction.

17. The non-transitory storage medium of claim 15, wherein the header includes a voting history of each of the nodes for the transaction, the voting history including identities of nodes in the distributed ledger and their votes.

18. The non-transitory storage medium of claim 17, further comprising receiving a request for the transaction at one of the nodes that voted to reject the transaction and redirecting the request to a node that voted to accept the transaction using the voting history stored in the header.

19. The non-transitory storage medium of claim 17, wherein the header is associated with proofs such that the header and/or the hash is verifiable.

20. The non-transitory storage medium of claim 17, wherein the hash is configured such that the nodes storing the hash in their respective ledgers comply with requirements of the distributed ledger.
